(19) United States
(12) Patent Application Publication
(10) Pub. No.: US 2005/0210697 A1
(43) Pub. Date: Sep. 29, 2005

(54) Type rule housing structure

(76) Inventor: Shih-Lin Lee, Taipei (TW)

Correspondence Address: APEX JURIS, PLLC, 13194 EDGEWATER LANE NORTHEAST, SEATTLE, WA, 98125, US

(21) Appl. No.: 10/808,851

(22) Filed: Mar. 25, 2004

(51) Int. Cl. G01B 3/10

(52) U.S. Cl. 33/767

(57) ABSTRACT

An improved type rule housing structure comprises essentially a housing, and a slip-resistant pad that is provided over the periphery of said housing by injection molding integrally together with said housing and extends from the upper edge of the front side of said housing toward the upper side and edges of left and right sides and further around the rear side to enclose the type rule at the middle of the lower side such that the upper and rear sides can be enclosed completely, while only the rear end of the lower side of said housing is enclosed; wherein several recessed portions are further provided regularly at the lower side of said housing for facilitating griping thereon by a user to achieve a slip-resistant effect; wherein said slip-resistant pad is protruded over every side of the housing such that, in case the housing being accidentally fallen down to the ground, the slip-resistant pad can contact with the ground first and absorb the impact force acting upon the housing so as to avoid the damage of said housing due to the impact.

### BACKGROUND OF THE INVENTION

1. Field of the Invention

The invention relates to an improved type rule housing structure, and in particular, to an improved type rule housing structure exhibiting slip-resistant and damping effects.

2. Description of the Prior Art

Conventional type rule housing structure such as described in, for example, U.S. Pat. No. 5,746,004, titled “TAPE RULE HOUSING”, is characterized in that it comprised:
(a) side walls;
(b) a peripheral wall extending therebetween with a bottom portion, upper portion, front end portion, and rear end portion, said walls providing an internal chamber therewithin, said peripheral wall having an aperture therein communicating with said chamber at the juncture between said bottom portion and said front end portion for passage of a tape rule blade therethrough, the juncture between said side walls and said upper portion of said peripheral wall being generally convexly arcuate, said housing walls having recessed portions extending over-the upper section of said rear end portion and the rearward, portion of said peripheral wall an the adjacent portion of said side walls, said housing side wall and peripheral wall being fabricated from synthetic resin and being provided by a pair of mating housing elements; and
(c) an elastomeric grip element seated in said recessed portions and extending over the upper section of said rear end portion and the rearward section of said upper portion of said peripheral wall and said adjacent portions of said side walls, and said grip element being adhesively bonded to said peripheral wall and side walls, said grip element having ribs extending transversely of said peripheral wall and spaced along the length thereof, said grip element providing a slip-resistant and comfortable gripping surface for the user's palm and thumb.

However, the grip element in the type rule structure disclosed in the above cited patent was seated in said recessed portions and extending over the upper section of said rear end portion and the rearward section of said upper portion of said peripheral wall and said adjacent portions of said side walls, and it did not house the entire type rule so that the slip-resistant effect was limited when it was gripped by the user. Further, said grip element was provided also a transverse rib which gave an uncomfortable feeling when the user grips the type rule again.

Accordingly, the above-described conventional type rule housing has many disadvantages, is not a perfect design and is desirable to be improved.

In view of the foregoing disadvantages associated with the conventional type rule housing, the inventor had been devoted to improve and innovate, and finally, after extensive studying for many years, had developed successfully an improved type rule housing structure according to the invention.

### SUMMARY OF THE INVENTION

The object of the invention is to provide an improved type rule housing structure characterized in that it has slip resistant effect upon gripping.

Another object of the invention is to provide an improved type rule housing structure characterized in that it has a damping effect.

Still another object of the invention is to provide a type rule housing characterized in that it has an aesthetic effect.

The improved type rule housing structure that can achieve the above-described effects comprises: a housing, provided at the bottom of its front side end with an exit for the type rule, and with a braking block near its upper end, wherein said braking block can brake said type rule; a slip resistant pad that extends from the upper edge of the front end of said housing toward the upper side and edges of left and right sides and further around the rear side to enclose the type rule at the middle of the lower side such that the upper and rear sides can be enclosed completely, while only the rear end of the lower side of said housing is enclosed; and wherein several recessed portions are provided regularly at the lower side of said housing to be gripped by an user and also to achieve a slip-resistant effect; and wherein said slip-resistant pad is protruded over each side of said housing such that, in case the housing being accidentally fallen down to the ground, the slip-resistant pad can absorb the impact force so as to avoid the damage of said housing due to the impact; and wherein said slip-resistant pad together with said housing can be provided with different colors to enhance the aesthetic feeling of the entire housing.

### BRIEF DESCRIPTION OF THE DRAWINGS

The drawings disclose an illustrative embodiment of the present invention which serves to exemplify the various advantages and objects hereof, and are as follows:

FIG. 1 is a three-dimensional schematic view of the improved type rule housing according to the invention;

FIG. 2 is a schematic view of the lower side of the improved type rule housing according to the invention;

FIG. 3 is a local exploded view of the improved type rule housing according to the invention; and

FIG. 4 is a schematic view showing the operation of the improved type rule housing according to the invention.

### DETAILED DESCRIPTION OF THE PREFERRED EMBODIMENT

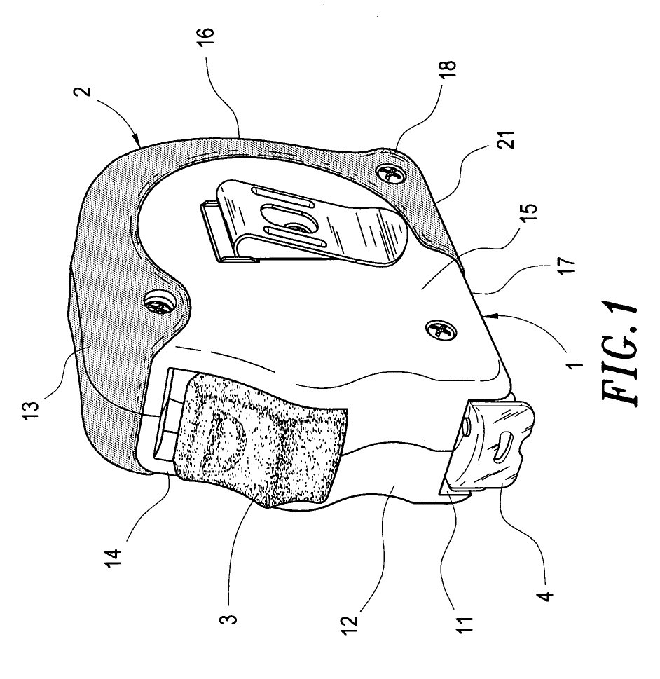

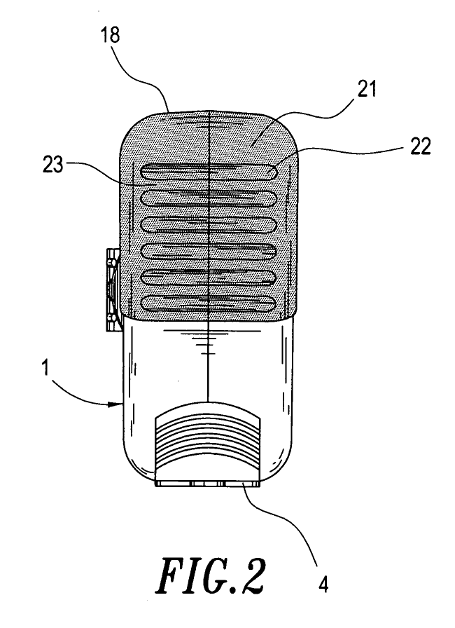

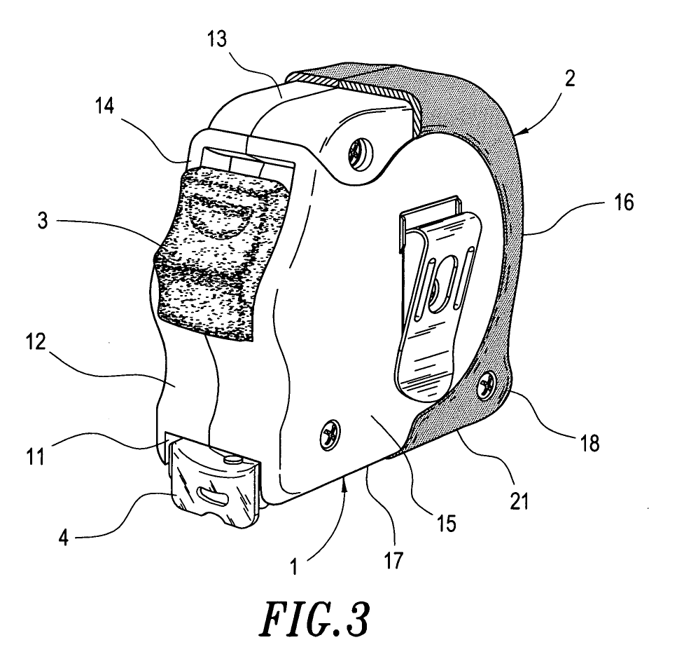

Referring to FIG. 1 to 3, the improved type rule housing structure according to the invention comprises essentially a housing 1, provided at the bottom of its front side end with an exit 11 for the type rule 4, and with a braking block 3 near its upper end, wherein said braking block 3 can brake said type rule 4; a slip-resistant pad 2 provided by injection molding integrally with rubber-like material around the periphery of said housing 1 and extends from the upper edge of the front side 12 of said housing 1 toward the upper side 13 and edges of left and right sides 14, 15, and further around the rear side 16 to enclose the type rule at the middle of the lower side 17 such that the upper side 13 and rear side 16 of said housing 1 is enclosed completely, while only the rear end of the lower side 17 of said housing 1 is enclosed; and wherein several recessed portions are provided regularly at the lower side 21 of said slip-resistant pad 2 in a manner that a slip-resistant protruding portion 23 is formed correspondingly; and wherein a locating block 18 is provided by extending from the junction of said lower side 17 and the rear side 16 of said housing 1 to be gripped by the finger of a user so as to achieve the effect of gripping stably; and wherein said slip-resistant pad 2 is protruded out of each side of said housing 1 to achieve a damping effect for preventing the damage said housing 1; and wherein said slip-resistant pad 2 together with said housing 1 can be provided with different colors to enhance the aesthetic feeling of the entire housing 1.

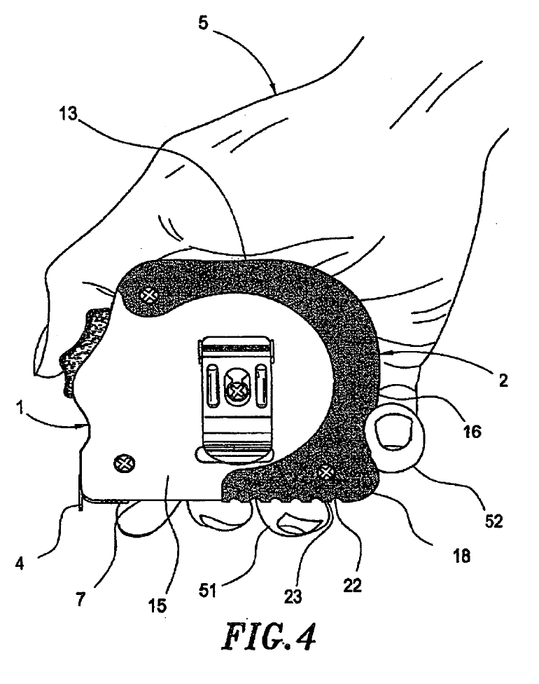

Referring to FIG. 4, a schematic view shows the operation of the improved type rule housing according to the invention, wherein, in practical operation, the user can grip said type rule housing 1 with his hand 5. Since the slip-resistant pad 2 is provided around every side of the housing 1, the hand 5 of the user can contact almost entirely with the slip-resistant pad 2 to achieve the slip-resistant effect. Further, the finger 51 of the user can hold the locating block 18 on the housing 1 and place on the slip-resistant protruding portion 23 of the slip-resistant pad 2 so as to grip the housing 1 more tightly and hence prevent the falling of the housing during operation. Furthermore, said slip-resistant pad 2 is protruded over each side of said housing 1 such that, in case the housing 1 being accidentally fallen down to the ground, the slip-resistant pad 1 can contact with the ground first and absorb the impact force acting upon the housing 1 so as to avoid the damage of said housing due to the impact.

The improved type rule housing structure according to the invention has following several advantages over the above-recited patent and the conventional technique:

1. In the improved type rule housing structure according to the invention, every side of the housing is enclosed and several recessed portions are provided regularly at its lower side such that the hand of the user can grip completely over the slip-resistant pad to ensure the effect of slip-resistance.

2. The slip-resistant pad in the improved type rule housing structure is protruded out of every side of the housing such that, in case the housing being accidentally fallen down to the ground, the slip-resistant pad can contact with the ground first and absorb the impact force acting upon the housing so as to avoid the damage of said housing due to the impact.

3. The slip-resistant pad together with said housing can be provided with different colors to enhance the aesthetic feeling of the entire housing.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

1. An improved tape rule housing structure, comprises a housing, provided at its front end with an exit for said tape rule; and with a braking block near its top end, and is characterized in that it comprises further:
a slip-resistant pad, provided over the periphery of said housing and extending from the upper edge of the front side of said housing toward the upper side and edges of left and right sides and further around the rear side to enclose the tape rule at the middle of the lower side such that the upper and rear sides can be enclosed completely, while only the rear end of the lower side of said housing is enclosed; and wherein said slip-resistant pad is protruded over each side of said housing to achieve a damping effect.

2. An improved tape rule housing structure as recited in claim 1, wherein several recessed portions are further provided regularly at the lower side of said housing such that a slip-resistant protruding portion is formed correspondingly to facilitate griping thereon.

3. An improved tape rule housing structure as recited in claim 1, wherein a locating block is further provided by extending from the junction of said lower side and the rear side of said housing in a manner that said locating block can be gripped by the finger of a user.

4. An improved tape rule housing structure as recited in claim 1, wherein said slip-resistant pad together with said housing can be provided with different colors to enhance the aesthetic feeling of the entire housing.

5. An improved tape rule housing structure as recited in claim 1, wherein said slip-resistant pad is made of a rubber material.

6. An improved tape rule housing structure as recited in claim 1, wherein said slip-resistant pad is formed integrally with said housing through injection molding.
